(19) United States
(12) Patent Application Publication
(10) Pub. No.: US 2004/0258785 A1
(43) Pub. Date: Dec. 23, 2004

(54) Single station dough press

(76) Inventor: James L. Schultz, Palos Heights, IL (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/464,217

(22) Filed: Jun. 18, 2003

(51) Int. Cl. A21C 11/00

(52) U.S. Cl. 425/89; 425/394

(57) ABSTRACT

A dough press machine is provided for flattening a quantity of dough. The dough press machine includes a cabinet having an upper platen and a lower platen and an extendable and retractable mechanism interposed between at least one of the platens and the cabinet to decrease and increase a space between the upper and lower platens. A sheet is interposed between the upper and lower platens and arranged such that the upper and lower platens will sandwich the sheet therebetween as the space between the platens decreases. The sheet is movable from between said platens to provide access to the sheet while being held in a horizontal orientation. A support structure extends between an upper and lower portion of the cabinet to interconnect such portions around a circumference of the platens such that no non-interconnected portion exceeds an angular extent of 165°.

### BACKGROUND OF THE INVENTION

The present invention relates to dough presses, and more particularly to a single station dough press for pressing dough products such as individual pizza crusts and tortillas.

A single station press for forming pizza crust is known, for example, as disclosed in U.S. Pat. No. 4,559,002, over which the present invention is an improvement. In that patent, it is disclosed to use a vertically reciprocating upper platen which is electrically heated to move down into engagement with a dough ball carried on a lower unheated platen to press the dough ball into a flat sheet which will be used as a pizza crust. The lower platen is pivotable about a vertical axis so that the lower platen will pivot horizontally out from under the upper platen to provide access to the lower platen for placement of a dough ball and removal of the flattened sheet. Appropriate safely mechanisms are provided to assure that the lower platen is returned to its proper location before the upper platen is permitted to extend downwardly to flatten the dough ball.

Controls are provided such as an adjustable thermostat control switch, a temperature indicating pilot light, a knob for controlling vertical movement of the platen and a timer control for regulating the dwell time between the cessation of the downward movement of the upper platen and the start of its upward movement. The upper platen is supported in a cantilevered arrangement, with the support frame having a generally C shape as seen in FIG. 2.

A similar apparatus is disclosed in U.S. Pat. No. 5,800,844. This patent discloses the use of an electric thrust actuator for moving the upper platen which has a linear load capacity of about 1,000 pounds. It is also suggested that the heated upper platen could be driven manually, hydraulically or pneumatically, as opposed to electro-mechanically. The upper platen is carried in a cantilevered manner on a C frame as shown in FIG. 2. The pivotally movable lower platen is unheated.

A single station pizza dough press is disclosed in U.S. Pat. No. 5,469,779 which has a reciprocal upper platen which may be heated and an unheated lower mold 69 which is reversible or changeable and which can be slid on tracks to align under the upper platen or slid out for access to place a ball of dough onto the lower mold. The upper platen is driven hydraulically to provide compression of the pizza dough in the range of 1,000 to 2,000 psi. A dual set of controls is required for operation of the press with the controls spaced apart sufficient to require a user to use two hands to operate the device. Nearly ½ of the upper and lower patens extend forwardly of the support frame, thus providing a circumferentially discontinuous interconnection between upper and lower portions of the housing around a circumference of the upper and lower platens exceeding 170°.

U.S. Pat. No. 4,417,867 discloses a mold assembly for flattening and reshaping pizza dough in a continuous automatic press which includes a planar base sheet in the form of a steel belt supported by a metal substrate for delivering a series of sequential dough masses and a mold carried on a reciprocating upper platen. The mold and the metal substrate each have a heating element located therein. No support frame or housing is disclosed.

### SUMMARY OF THE INVENTION

The present invention provides an improvement over the above described prior art devices wherein a single station press is provided with various molds for forming various shaped pizza crusts.

A dough press machine for flattening a quantity of dough, such as dough to be used for pizza crusts, tortillas and other flattened dough products is provided with a cabinet having a upper platen and a lower platen. An extendable and retractable mechanism is interposed between at least one of the platens and the cabinet to decrease and increase a space between the upper and lower platens to flatten dough products placed therebetween. A sheet is interposed between the upper and lower platens and arranged such that the upper and lower platens will sandwich the sheet therebetween as the space between the platens decreases. The sheet is movable from between the platens to provide access to the sheet and the dough product is to be placed on top of the sheet for flattening.

In an embodiment, the extendable and retractable mechanism comprises an electric thrust actuator interposed between the cabinet and the upper platen.

In an embodiment, the extendable and retractable mechanism comprises a hydraulic cylinder interposed between the cabinet and the upper platen.

In an embodiment, the upper platen is heated and in an embodiment, the lower platen is heated. In an embodiment, they are both heated.

In an embodiment, the extendable and retractable mechanism is interposed between the cabinet and the upper platen.

In an embodiment, the sheet is carried on a drawer mechanism that slides relative to the platens.

In an embodiment, the drawer mechanism comprises a substantially solid front to prevent access between the platens when the drawer is slid between the platens.

In an embodiment, the sheet is formed from a non-stick and heat resistant plastic material.

In an embodiment, whether or not a sheet is interposed between the platens, the cabinet comprises support structures extending between an upper portion of said cabinet to which the upper platen is secured and a lower portion of said cabinet to which the lower platen is secured, the support structures interconnecting the upper and lower portions around a circumference of the upper and lower platens such that the interconnections are provided at angular locations not exceeding 165°.

In an embodiment, the support structure comprises three support posts arranged at approximately 120° to each other around the platens.

In an embodiment, the support structure comprises at least one interconnection between the upper portion and the lower portion forward of a side to side centerline of the platens.

### BRIEF DESCRIPTION OF THE DRAWING

FIG. 1 is a front elevational view of a pizza press embodying the principles of the present invention.

FIG. 2 is a side elevational view of the pizza press of FIG. 1 with the drawer in the closed position.

FIG. 3 is a side elevational view of the pizza press of FIG. 1 with the drawer in the open position.

FIG. 4 is an exploded isometric view of the drawer structure.

FIG. 5 is a plan view of the support structure.

FIG. 6 is an isometric view of the drawer and lower platen portion of the press in a dough ball loading stage.

FIG. 7 is an isometric view of the drawer in a ready to press position.

FIG. 8 is an isometric view of the drawer in a pizza crust unloading position.

### DETAILED DESCRIPTION OF THE PREFERRED EMBODIMENT

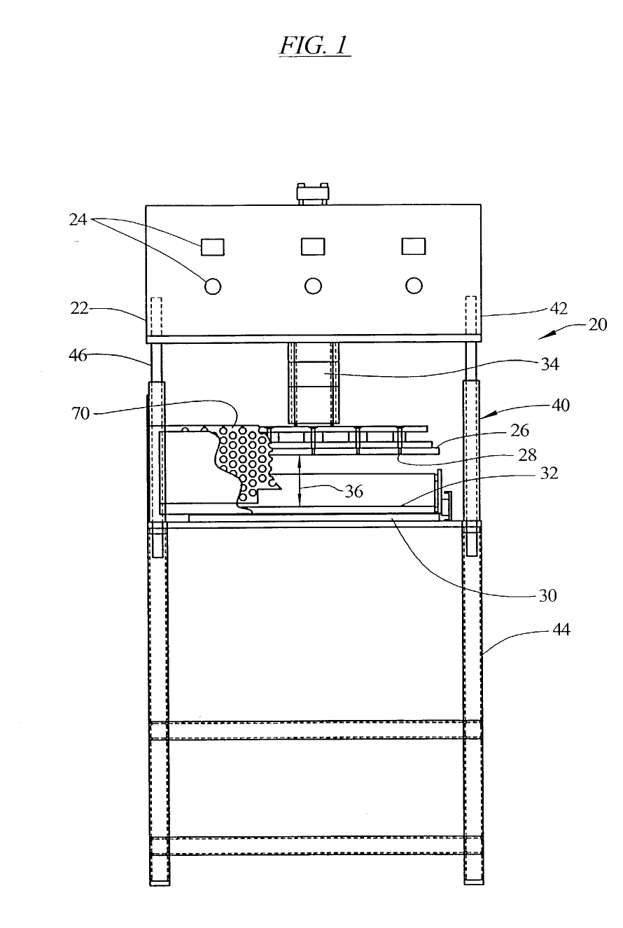

In FIGS. 1-3 there is illustrated a dough press machine generally at 20 which can be used for flattening a quantity of dough, such as into pizza crusts, tortillas or other flattened dough products.

The dough press machine 20 includes a cabinet 22 which may have a plurality of controls 24 thereon for controlling various operations of the machine as described below. Supported by the cabinet 20 is an upper platen 26 which has a generally horizontal lower surface 28 for engaging the dough to be flattened. Various shaped molds may be attached to the bottom of the upper plate 26 to produce dough products with various shapes, such as pizza crusts with circumferential raised rims. The cabinet 22 also supports a lower platen 30 which has a horizontal upper surface 32 for supporting the dough.

An extendable and retractable mechanism 34 is secured to the cabinet and is shown as being interposed between the upper platen 26 and the cabinet 22, although it could alternately be positioned between the lower platen 30 and the cabinet 22, or two mechanisms could be provided, one between the cabinet and each of the platens. The extendable and retractable mechanism 34, which may be an electric thrust actuator, a hydraulic cylinder, or a mechanical crank and lever mechanism or similar mechanisms, is used to decrease and increase a space 36 between the upper and lower platens 26, 30. The pressure provided by the movement of the platens towards one another, sandwiching the dough therebetween, provides for the thickness of the resulting flattened dough piece. Different doughs have different consistencies and properties, which require different pressures to achieve the desired results. To apply high pressures, on the order of 2,000 to 3,000 psi, which is required or desirable for some doughs, it is necessary to provide sufficient support for the platens and interconnections between different portions of the cabinet, as described below.

Preferably the lower platen 30 remains stationary and the upper platen 26 reciprocates vertically, but the movement could also be reversed. Upon the movement of the two platens towards each other, a ball of dough is pressed into a flat disk either to a preset thickness or by the application of a preset pressure applied by the platens. Either or both of the upper 26 and lower 30 platens may be heated, through the use of removable and replaceable heating elements. By heating the dough as it is being flattened, and particularly where the platens “dwell” at a minimum distance from each other for a selected period of time, a skin will form on the outside of the dough rendering it non-sticky, which assists in the removal of the dough from between the platens. The heating of the dough also “relaxes” the dough and allows it to retain its flattened shape without pulling back towards its pre-flatted shape.

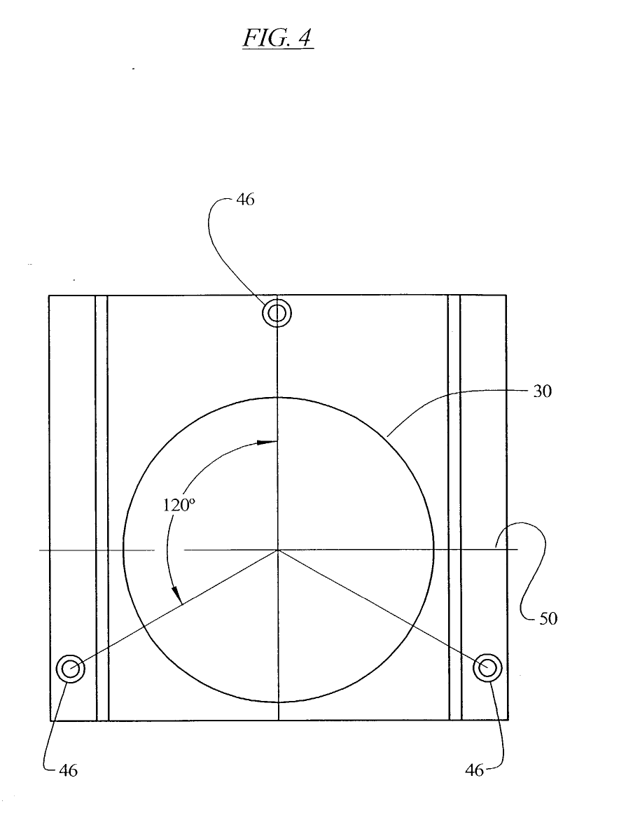

In an embodiment of the invention, a support structure 40 extends between an upper portion 42 of the cabinet 22 to which the upper platen 26 is secured and a lower portion 44 of the cabinet to which the lower platen 30 is secured. The support structure 40 is illustrated in FIGS. 1-4 as being in the form of three separate posts 46, although the support structure could take other forms, such as plates, walls and other frame elements. In order to provide sufficient support to prevent bending of the support structure 40 as the platens press against each other at high pressures or requiring an overly massive support structure, the support structure interconnects the upper 42 and lower 44 portions around a circumference of the upper 26 and lower 30 platens such that the interconnections are provided at angular locations not exceeding 165°. That is, the support structure 40 provides a circumferentially discontinuous interconnection between the upper 42 and lower 44 portions around a circumference of the upper 26 and lower 30 platens such that no non-interconnected portion exceeds an angular extent of 165°. In this way, the platens are not provided with only a cantilevered support. In the embodiment illustrated, the posts 46 are arranged at approximately 120° to each other around the platens 26, 30. While other support structures could be utilized, in this embodiment of the invention, it is important that the support structure 40 interconnect the upper 42 and lower 44 portions of the housing 22 at at least one location forward of a side to side centerline 50 of the platens 26, 30. A circumferentially discontinuous interconnection in the range of 100° to 165° still allows for a sufficiently large opening to permit access for placing and removing the dough product between the platens in the manner desired below.

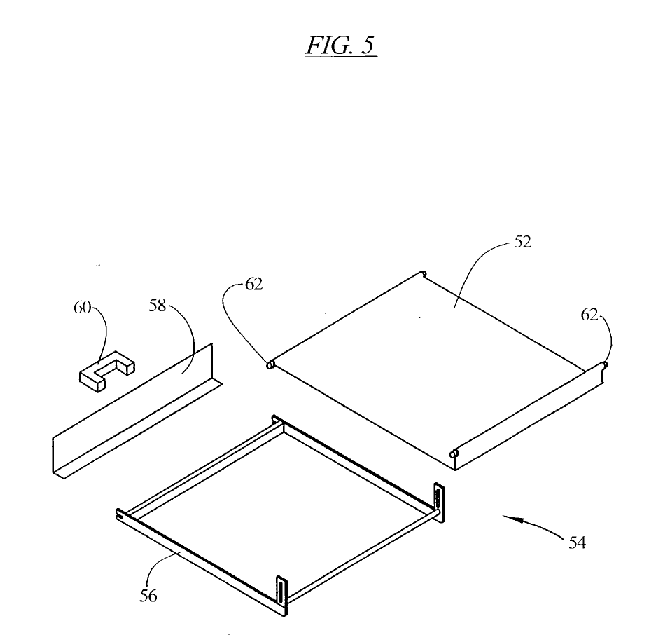

In an embodiment of the invention, a sheet 52 is interposed between the upper 26 and lower 30 platens and is arranged such that said upper and lower platens will sandwich the sheet therebetween as the space between the platens decreases. In an embodiment such as the one illustrated, particularly in FIGS. 5-8, the sheet 52 is carried on a drawer structure 54 which includes a drawer frame 56, a front guard piece 58, and an operator handle 60. The sheet 52 may comprise a belt of non-stick and heat resistant material, for example a plastic material such as Teflon, or a material coated with a plastic material such as Teflon.

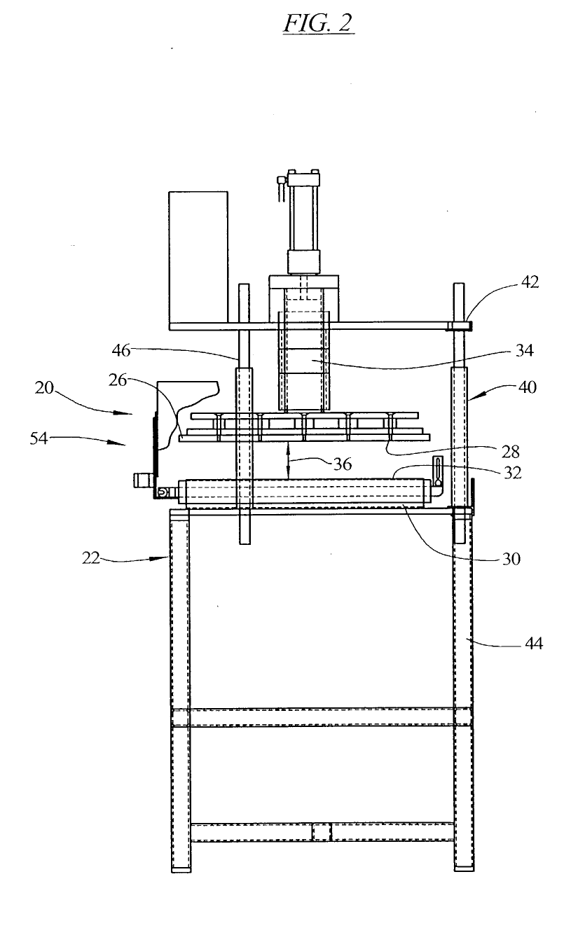

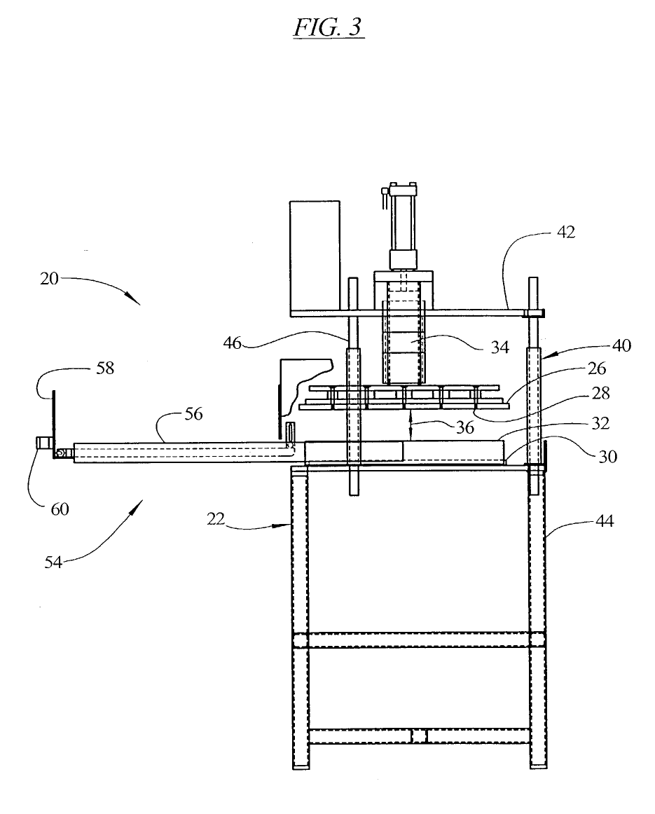

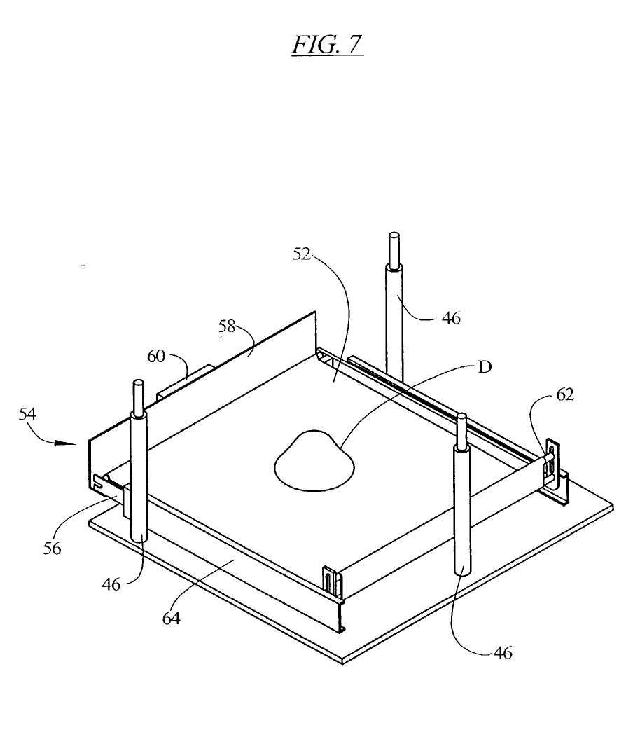

In the embodiment illustrated, the sheet is a flexible belt and is stretched around the drawer frame 56 and is held in place by two support shafts 62 that engage with the frame 56. The sheet 52 forms a floor of the drawer structure 54 and the drawer frame 56 does not otherwise have a floor structure. The drawer frame 56 can slidingly engage with drawer slides 64 supported on the cabinet such that the entire drawer frame 56 and sheet 52 can slide out from between the platens 26, 30 (FIGS. 3, 6 and 8) and can slide into a position between the platens (FIGS. 2 and 7).

The front guard piece 58 is preferably sized, shaped and positioned so as to comprise a substantially solid (but not necessarily without perforations) front member to prevent access between the platens 26, 30 when the drawer structure 54 is slid between the platens. In this way, an operator of the press will not be able to inadvertently insert his fingers between the platens while they are moving together. Additional guard material, preferably in the form of perforated walls 70, are provided around the perimeter of the platens to prevent crush or burn injuries.

The controls are utilized to set a number of parameters for the operation of the press and to actuate the movement of the platens. For example, the temperatures of the upper and lower platens may be adjustable through the use of the controls, the distance of travel of the movable platen(s) may be controlled, the pressure applied by the platens, and the dwell time that the platens remain at their closest separation distance, may all be controlled through the controls. Various safety features, including requiring two spaced apart controls to be manually depressed and remain depressed to move the platens together may be incorporated in the machine control.

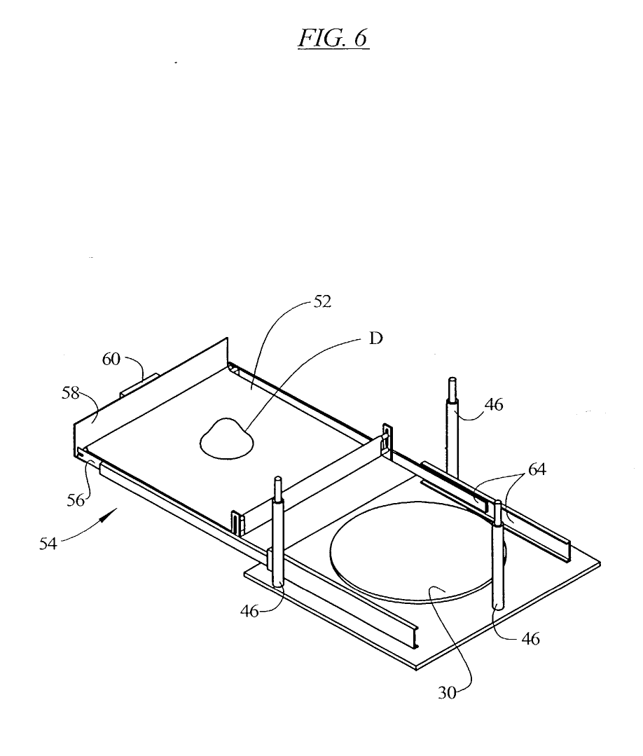

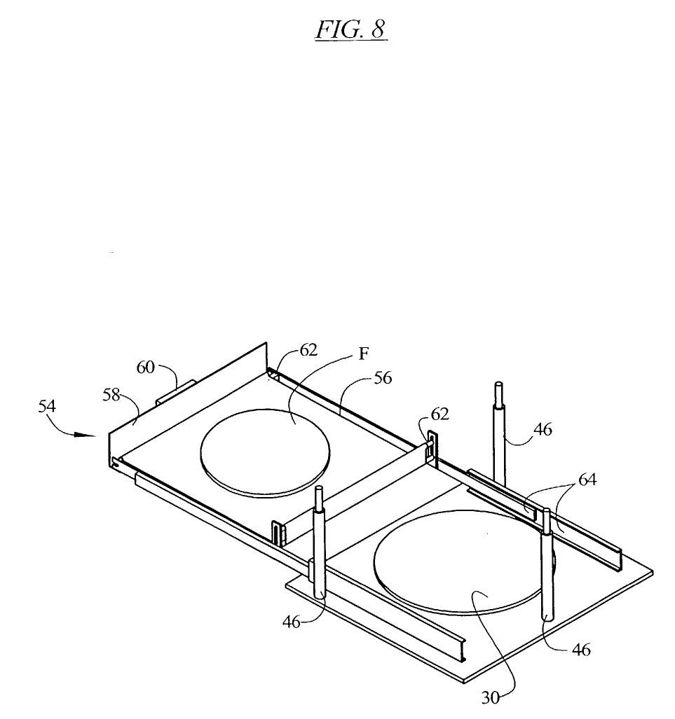

As seen in FIG. 6, the drawer frame 56 and sheet 52 are slid out from between the platens and a ball of dough D is placed onto the sheet. In FIG. 7, The drawer frame 56 and sheet 52 are shown as being slid back in between the platens. One or both of the platens are then moved toward the other to flatten the dough, and the drawer frame 56 and sheet 52 are then slid back out from between the platens, resulting in the arrangement as shown in FIG. 8. At this point the flattened dough product F can be easily removed from the sheet for further processing. If the upper platen is heated, the flattened dough piece will fall away from the platen as it is moved upwardly. If the lower platen is heated, the flattened dough piece will easily release from the sheet 52. If the sheet 52 is formed of a flexible belt material, a tool, such as a flat implement, can be used to easily slide under the flattened dough product, particularly due to the “give” of the flexible sheet.

The operator is never exposed to the hot surfaces of the platens since only the sheet 52 is movable for presentation of the flattened dough piece, not the lower platen 30 itself. When the sheet is made from a material such Teflon, it will not retain the heat of the platens and will not readily transmit that heat to the operator. Thus the risk of burns from the heated platens is substantially eliminated.

Although the sheet 52 is illustrated as being slid into and out of the position between the platens, that is, being moved in a linear movement by a mechanism such as with a drawer structure, the movement of the sheet could be accomplished in different ways in accordance with the principles of the present invention. For example, the sheet could be supported on a pivotable structure such that it would horizontally pivot about a vertical pivot axis into and out of the position between the platens. The sheet could also be arranged on a structure that pivoted about a horizontal axis, while maintaining the sheet substantially horizontal, to swing the sheet into and out of the position between the platens. In order to maintain the dough ball on the sheet before it is flattened, and the flattened dough product on the sheet after it is flattened, preferably the sheet is maintained in a substantially horizontal orientation as it is moved in and out of the position between the platens.

Although the sheet is illustrated as a flexible belt material, it can also be provided as a rigid material. Preferably the sheet is formed of a heat transmissive material, particularly when the lower platen is heated, and also, preferably, the sheet does not retain the heat, so as to reduce potential burn injury to an operator.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

The embodiments of the invention in which an exclusive property or privilege is claimed are defined as follows:

1. A single station dough press machine for flattening a quantity of dough, the dough press machine comprising:
a cabinet having an upper platen and a lower platen,
an extendable and retractable mechanism interposed between at least one of said platens and said cabinet to decrease and increase a space between said upper and lower platens, and
a sheet interposed between said upper and lower platens and arranged such that said upper and lower platens will sandwich said sheet therebetween as the space between said platens decreases,
said sheet being movable from between said platens to provide access to said sheet.

2. A dough press machine according to claim 1, wherein said extendable and retractable mechanism comprises an electric thrust actuator interposed between said cabinet and said upper platen.

3. A dough press machine according to claim 1, wherein said extendable and retractable mechanism comprises a hydraulic cylinder interposed between said cabinet and said upper platen.

4. A dough press machine according to claim 1, wherein said upper platen is heated.

5. A dough press machine according to claim 1, wherein said lower platen is heated.

6. A dough press machine according to claim 1, wherein said extendable and retractable mechanism is interposed between said cabinet and said upper platen.

7. A dough press machine according to claim 1, wherein said sheet is carried on a drawer mechanism that slides relative to said platens.

8. A dough press machine according to claim 6, wherein said drawer mechanism comprises a substantially solid front to prevent access between said platens when said drawer is slid between said platens.

9. A dough press machine according to claim 1, wherein said sheet is formed from a non-stick and heat resistant plastic material.

10. A dough press machine according to claim 1, wherein said cabinet comprises support structures extending between an upper portion of said cabinet to which said upper platen is secured and a lower portion of said cabinet to which said lower platen is secured, said support structures interconnecting said upper and lower portions around a circumference of said upper and lower platens such that no non-interconnected portion exceeds an angular extent of 165°.

11. A dough press according to claim 1, wherein said sheet is carried on a structure which maintains said sheet in a substantially horizontal orientation as it is moved from between said platens.

12. A single station dough press machine for flattening a quantity of dough, the dough press machine comprising:
a cabinet having an upper portion to which an upper platen is secured and a lower portion to which a lower platen is secured,
an extendable and retractable mechanism interposed between at least one of said platens and said cabinet to decrease and increase a space between said upper and lower platens,
a support structure extending between said upper portion and a lower portion, said support structure providing a circumferentially discontinuous interconnection between said upper and lower portions around a circumference of said upper and lower platens such that no non-interconnected portion exceeds an angular extent of 165°, and
a sheet interposed between said upper and lower platens and arranged such that said upper and lower platens will sandwich said sheet therebetween as the space between said platens decreases,
said sheet being movable from between said platens to provide access to said sheet.

13. A dough press according to claim 12, wherein said support structure comprises three support posts arranged at approximately 120° to each other around said platens.

14. A dough press according to claim 12, further including a sheet carried on a structure which maintains said sheet in a substantially horizontal orientation as it is moved from between said platens.

15. A dough press machine for flattening a quantity of dough, the dough press machine comprising:
a cabinet having a heated upper platen and a heated lower platen,
said cabinet comprises support structures extending between an upper portion of said cabinet to which said upper platen is secured and a lower portion of said cabinet to which said lower platen is secured, said support structures interconnecting said upper and lower portions around a circumference of said upper and lower platens such that said interconnections are provided at angular locations not exceeding 165° apart,
an extendable and retractable mechanism interposed between said upper platen and said cabinet to decrease and increase a space between said upper and lower platens,
a sheet carried on a drawer mechanism interposed between said upper and lower platens and arranged such that said upper and lower platens will sandwich said sheet therebetween as a space between said platens decreases, said sheet being slidable relative to said platens to provide access to said sheet.

16. A dough press machine according to claim 15, wherein said extendable and retractable mechanism comprises an electric thrust actuator interposed between said cabinet and said upper platen.

17. A dough press machine according to claim 15, wherein said extendable and retractable mechanism comprises a hydraulic cylinder interposed between said cabinet and said upper platen.

18. A dough press machine according to claim 15, wherein said sheet is formed from a non-stick and heat resistant plastic material.

19. A dough press machine according to claim 15, wherein said drawer mechanism comprises a substantially solid front to prevent access between said platens when said drawer is slid between said platens.
